(19) United States
(12) Patent Application Publication
(10) Pub. No.: US 2002/0114682 A1
(43) Pub. Date: Aug. 22, 2002

(54) Concrete screw

(76) Inventor: Hubert Forster, Moorenweis (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 10/075,495

(22) Filed: Feb. 13, 2002

(30) Foreign Application Priority Data
Feb. 19, 2001 (DE) 10107801.3

(51) Int. Cl. F16B 35/04

(52) U.S. Cl. 411/411

(57) ABSTRACT

A self-tapping screw comprised of a shank (1) whose end on the setting side is tapered and a thread (2) with a cylindrical external contour. A pilot thread (3) is connected to the end of the thread (2) on the setting side; the pilot thread having a thread pitch width that diminishes in the setting direction (S) for providing better insertion behavior. The screw further comprises a trailer thread (4) with a diminishing thread pitch width (b3) for improving the loosening behavior.

### BACKGROUND OF THE INVENTION

The invention relates to a self-tapping screw, particularly, a concrete screw, comprised of a shank and a thread with a cylindrical external contour, wherein the shank has a setting-side end that is tapered and an opposite end that has a torque or load attachment means and wherein the thread extends at least partially over the length of the shank.

Self-tapping screws of the type described above have been known for a long time and have a shank with a thread at least on its partial outer surface. The threads of such screws, for example, are provided with different recesses and different flank angles and different profile angles. Screws of this type are screwed directly into a substrate or turned in after having created a bore hole in the substrate. It is well-known that with increasing depth of penetration of the screw an increasingly greater force is required to establish fixation.

DE-U1-29812526 discloses such a self-tapping screw comprised of a shank and a thread, that extends at least partially over the length of the shank. On the setting-side end the shank is cone-shaped. Furthermore, the thread is characterized by a cylindrical external contour.

Such a prior art screw is advantageously characterized by a high extraction force that is independent of the quality of the bore hole.

In the conventional prior art solution, when inserting the screw, increasingly greater insertion torque is required as the insertion depth gets greater. Disadvantageously, the increase of the insertion torque results in inadequate tapping behavior and can, depending on the surface, result in breakage of the screw.

Furthermore, disassembly of the fastening, particularly of the screw, is made significantly more difficult, since the loosening torque required, depending on ambient conditions, is somewhat greater than the tapping torque.

### SUMMARY OF THE INVENTION

The object of the present invention is to provide a self-tapping screw that is characterized by consistently convenient insertion and removal behavior. Further, the object is to provide a screw that is economical to manufacture.

According to the invention, this object is achieved by a pilot thread that is arranged at the setting end of the thread, wherein the pilot thread has a decreasing pitch dimension in the leading end. As a result of this arrangement, the pilot thread penetrates like a chisel into a surface, in particular concrete.

After transition of the pilot thread into the principal thread, both thread types have identical pitch dimensions. Consequently, the actual thread grips into the tapped path created by the pilot thread. Naturally, the screw can also have a plurality of thread pitches. In the embodiment described, each of the thread pitches advantageously has a pilot thread.

Preferably, a trailer thread is associated with the end of the thread facing away from the leading setting-end of the thread and the trailer thread has a decreasing pitch dimension in setting-end. The trailer thread improves the loosening of the screw from the surface, particularly from the bore hole.

The pilot thread and the trailer thread advantageously encircle the shank respectively by 180°. Because the pilot thread and the trailer thread each extend over half of the external periphery of the screw, the insertion behavior and the extraction behavior is optimal. Should the screw be optimized for a surface having an extremely high or low hardness, then the structure of the pilot and trailer thread can be fashioned with a 90° to 270° range.

In a preferred embodiment, the pilot thread is characterized, in the setting direction, by a decreasing external diameter to facilitate insertion into the surface.

Preferably, the external diameter of the thread corresponds to 1.3 to 1.6 times the core diameter of the shank to achieve high loads and satisfactory insertion behavior.

In a preferred embodiment, the pitch dimension of the thread corresponds approximately to 0.075 to 0.125 times the core diameter of the shank to optimally match the pitch dimension to the structure of the rest of the screw.

Advantageously, the conically formed end of the shank is free of thread to allow for economical manufacture.

The features of the present invention will become more apparent from the following description of the invention which refers to the accompanying drawings.

### BRIEF DESCRIPTION OF THE DRAWINGS

FIG. 1 illustrates a lateral view of the screw, in accordance with the invention;

FIG. 2 illustrates an enlarged lateral view of the setting end of the screw represented in FIG. 1., in accordance with the invention

### DETAILED DESCRIPTION OF THE INVENTION

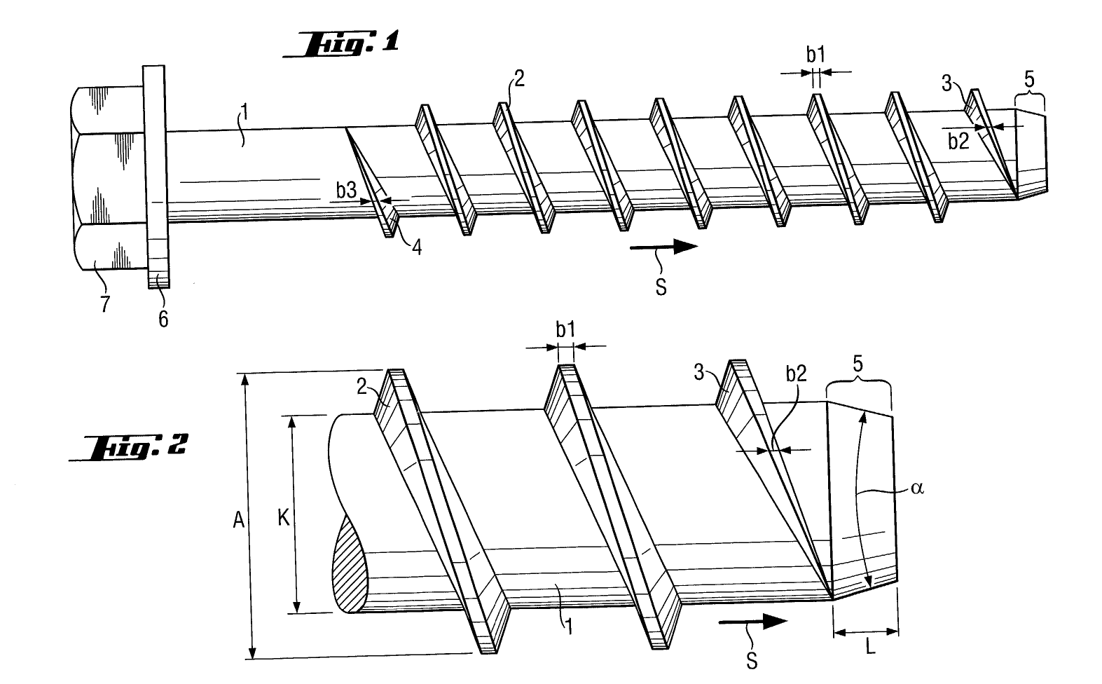

Referring to FIG. 1, a screw is represented according to the invention, in particular a concrete screw, comprised of a shank 1, that is formed conically at the setting end and at whose opposite end a torque and load fastening means is provided.

A cylindrical thread 2 is arranged on the shank 1 between the load fastening means and the conical zone 5. The thread pitch width b1 of the thread 2 extends parallel to the axis of the shank 1. At the end of the thread 2 on the setting side a pilot thread 3 is arranged, whose thread pitch width b2 decreases in the setting direction S. Facing the setting direction, a trailer thread 4 is connected to the thread 2 and the thread pitch width b3 diminishes on the side facing in the setting direction S. The thread amplitude of the pilot thread 3 and of the trailer thread 4 is reduced, in the same direction, as the respective corresponding thread pitch widths b2, b3, as such widths b2, b3 diminish. The pilot thread 3 and the trailer thread 4 each extend over half the periphery of the shank 1; that is, 180°.

The conical region of the shank, in particular truncated conically shaped region 5, has a base angle α of approximately 30° and narrows in the setting direction S. The longitudinal extent L of the thread-free zone corresponds approximately to 0.5 times the core diameter K of the shank 1.

The load fastening means is formed, for example, by a washer 6 and the torque attachment means is formed, for example, by a polygonal head 7. Both the washer 6 and the polygonal head 7 are designed in one piece with the shank 1.

The external diameter A of the thread 2 corresponds to 1.5 times the core diameter K of the shank 1. The thread pitch width b 1 of the thread 2 is approximately 0.1 times the core diameter of the shank 1.

What is claimed is:

1. A self-tapping screw comprising a shank (1) and a thread (2) with a cylindrical outer contour, the shank (1) has a first end with a setting side that is tapered and a second end opposite the first end where a torque and load connection means is provided, the thread (2) extends at least partially over the length of the shank (1), wherein a pilot thread (3) is connected to the first end of the thread (2) on the setting side and the pilot thread has a thread pitch width (b2) that diminishes in the setting direction (S).

2. The screw of claim 1, wherein a trailer thread (4) is connected to the second end of the thread (2) facing away from the setting end and the trailer thread (4) has a thread pitch width (b3) that diminishes on the side facing the setting side (S).

3. The screw of claim 1, wherein the pilot thread (3) and the trailer thread (4) each encircle the shank (1) by an angle of approximately 180°.

4. The screw of claim 1, wherein the pilot thread (3) has a diminishing external diameter in the setting direction (S).

5. The screw of claim 4, wherein the external diameter (A) of the thread (2) corresponds to 1.3 to 1.6 times a core diameter (K) of the shank (1).

6. The screw of claim 5, wherein the thread pitch width (b1) of the thread (2) corresponds approximately to 0.075 to 0.125 times the core diameter (K) of the shank (1).

7. The screw of claim 1, wherein the tapered end (5) of the shank is free of thread.

8. The screw of claim 1, wherein the screw is a concrete.
